(19) United States
(12) Patent Application Publication
(10) Pub. No.: US 2016/0047322 A1
(43) Pub. Date: Feb. 18, 2016

(54) METHOD AND DEVICE FOR REDUNDANTLY CONTROLLING THE SPEED OF AN INTERNAL COMBUSTION ENGINE

(71) Applicant: MTU FRIEDRICHSHAFEN GMBH, Friedrichshafen (DE)

(72) Inventors: Jan HENKER, Meckenbeuren (DE); Jörg BARRHO, Radolfzell (DE)

(21) Appl. No.: 14/780,081

(22) PCT Filed: Mar. 6, 2014
(86) PCT No.: PCT/EP2014/000574

§ 371 Date: Sep. 25, 2015

(30) Foreign Application Priority Data
Mar. 28, 2013 (DE) 10 2013 205 618.4

(51) Int. Cl. F02D 31/00; F02D 41/00

(52) U.S. Cl. CPC F02D 31/001; F02D 41/009

(57) ABSTRACT

A method for redundantly controlling a speed of an internal combustion engine, in particular of a vehicle, which includes a redundantly actuatable actuator for adjusting the speed, the method includes the following steps: detecting a first actual speed and a second actual speed of the internal combustion engine, wherein the actual speeds are detected simultaneously and independently of one another; detecting a first actual position and a second actual position of the actuator, wherein the actual positions are detected simultaneously and independently of one another; determining a plausible actual speed and a plausible actual position in accordance with the detected actual speeds and/or the detected actual positions; and actuating the actuator for adjusting the speed in accordance with the plausible actual speed and the plausible actual position.

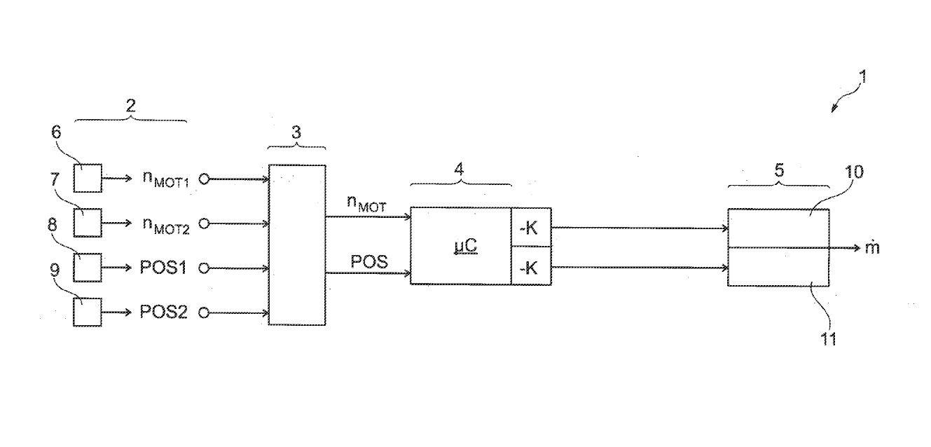

The invention pertains to a method for redundantly controlling the speed of an internal combustion engine and to a corresponding device.

Methods and devices for automatically controlling the speed of internal combustion engines are known from the prior art. For this purpose, an actuator of an internal combustion engine is operated by two redundant systems, one of which can be called the main system and the other the fail-safe system. Whereas it is assumed that, in the normal case, the main system, also called “master system”, operates the speed-controlling actuator without error, the fail-safe system, also called “backup” system, is provided, so that it can take over the responsibility for operating the actuator when an error or an unclear situation has occurred.

For example, an open-loop control system for an electrical fuel pump, in which the speed of the crankshaft of an internal combustion engine is detected by a two sensors is known from Offenlegungsschrift No. DE 41 33 558 A1. The acquired data are subjected to a plausibility check before they are evaluated for the actuation of the fuel pump.

A method similar in principle is known from Offenlegungsschrift No. DE 102 01 166 A1, wherein, instead of the rotational speed, the angular position of a shaft is determined redundantly. Transmitter-type sensors are provided, the output values of which are subjected to a plausibility test before they are used for the actuation.

The methods known from the cited publications have in common that the actuator is operated by only a single adjusting mechanism, and only the data necessary for operation are detected by the redundant sensors. If a system like this is developed into a completely redundant system comprising two operating strands independent of each other, then each of these subsystems requires it own computing unit, especially a master unit and a backup computing unit, which work independently of each other. So that no malfunctions are triggered during operation, the computing units must also communicate with each other. So that no errors occur, a great deal of effort is required to prevent the control devices from deactivating each other, as a result of which the speed control system fails completely in the end.

The invention is therefore based on the goal of creating a method and a device for redundant speed control which prevents, easily and at low cost, the speed control system from failing completely, and which simultaneously guarantees the full functionality of the redundant speed control.

The goal on which the invention is based is achieved by a method with the features of claim 1. The method according to the invention offers the advantage that the fully redundant system requires only a modest amount of computing effort, in spite of which complete failure is reliably avoided. According to the invention, it is provided for this purpose: that a first actual speed and a second actual speed of the internal combustion engine are detected simultaneously and independently of each other; that a first actual position and a second actual position of the actuator are detected simultaneously and independently of each other; that a plausible actual speed and a plausible actual position are determined as a function of the detected actual speeds and/or the detected actual positions; and that the actuator is operated as a function of the plausible actual speed and the plausible actual position to adjust the speed of the internal combustion engine. The actuator can be, for example, a control rod which determines the supply of fuel to the internal combustion engine. According to the invention, therefore, the actual speeds and the actual positions, which are detected independently of each other, are first subjected to a plausibility test, which is conducted in particular by a single computing unit. Plausible values are extracted from the detected values, and these plausible values are then used to operate the actuator. Instead of a master strand and a backup strand being able to interfere with each other, the method according to the invention guarantees that the speed control function continues to operate, at least as long as both strands are not suffering from a malfunction at the same time. The plausibility test can be conducted with little effort by comparing the values in question with each other or with other values, so that the overall amount of computing work is also kept very modest.

According to an advantageous elaboration of the invention, it is provided that, to determine a plausible actual speed, the detected actual speeds are compared with an allowable, presettable speed range, and that, of the detected actual speeds, only an actual speed lying within the allowable speed range is judged to be a plausible actual speed. The allowable speed range is determined as a function of a previously detected speed, for example, so that a speed gradient is taken into consideration in the process of determining the plausibility of the actual speed just now being detected. If one of the actual speeds is too far outside the allowable speed range, it cannot be plausible and is not used for the further operation of the actuator.

According to an advantageous elaboration of the invention, it is provided that, to determine the plausible actual speed, the detected actual speeds are compared with each other, and that, if the detected actual speeds deviate from each other by a presettable amount, only the detected actual speed which lies within the allowable speed range is judged as being plausible. In addition to the comparison with the speed range, therefore, the actual speeds are also compared with each other, specifically during an initial step. If the actual speeds are not so far apart from each other that they exceed a presettable speed deviation, both can be considered plausible, insofar as they are within the speed range. If one of the actual speeds deviates to such an extent that it lies outside the speed range, then only the speed lying within the speed range is considered plausible. If the speed deviation is less than the presettable deviation, preferably a comparison with the presettable speed range is omitted, because then it can be assumed that both systems are operating without error.

According to an advantageous elaboration of the invention, it is provided that, if the speed deviation between the actual speeds lies below a presettable limit value and both detected actual speeds lie within the allowable speed range, of the two actual speeds only one, especially the first, actual speed is judged plausible. If both actual speeds are within the presettable range and they do not deviate too far from each other, it is necessary to decide which of the detected actual speeds should be used to operate or to activate the actuator. It is preferably provided that the first speed, i.e., that of the master or main system, be used. In principle, of course, the second speed could also be used.

According to a preferred elaboration of the invention, it is provided that, when the speed deviation of the actual speeds lies below a presettable limit value, an average value is formed from the detected actual speeds, and this average is determined to be the plausible actual speed. In this embodiment, therefore, it is provided that neither of the two acquired speed values is selected and evaluated; instead, an average is formed from the two detected speed values, and this average is determined to be the plausible actual speed.

According to an especially preferred elaboration of the invention, it is provided that the detected actual positions are compared with each other, wherein, if the detected actual positions deviate from each other by more than a presettable amount, only one of the acquired actual positions, in particular the second acquired actual position, is judged to be plausible. If the actual positions therefore deviate sufficiently far from each other, it is preferably assumed initially, for the sake of simplicity, that the first actual position was not determined correctly.

According to an alternative embodiment of the invention, it is provided that the first actual position is compared with the first actual speed and the second actual position is compared with the second actual speed, wherein, as a function of the comparison, it is determined whether the actual position in question is plausible. If the detected actual speed does not correspond to the speed which would be expected at the detected actual position, then it can be assumed that there is an error in the system. If it was established previously that the detected actual speeds were close together, then it can be assumed that the detected actual position was determined incorrectly. If, however, the detected actual speed corresponds to the actual position, then this acquired actual position can be considered plausible.

It is also preferably provided that the redundantly controllable actuator comprises two operating devices, wherein the first actual speed and the first actual position are assigned to a first operating device, and the second actual speed and the second actual position are assigned to the second operating device, wherein only the operating device whose actual speed and actual position have been judged plausible is activated. The redundant operation or quasi-redundant operation of the actuator can be achieved even if, as is preferred, only one computing unit is provided. In the present case, it is provided for this purpose that the only values which are used are those of the system in which the actual speed and the actual position were judged plausible. If both systems are determined plausible, then according to the criteria described above, one of the systems is selected as plausible. If the plausibility test shows that one of the systems contains implausible values or an implausible speed and/or an implausible actual position, then at least one error message is generated, which alerts the user to an error in the (sub)system.

The goal on which the invention is based is also achieved by the device according to the invention with the features of claim 9. This device is characterized by a redundantly controllable actuator, wherein, for the redundant control of the actuator, the following elements are provided: a main system comprising a first speed sensor for detecting a first actual speed of the internal combustion engine, a first position sensor for detecting a first actual position of the actuator, a computing unit, and in particular a first operating device, and a backup system comprising a second speed sensor for detecting a second actual speed of the internal combustion engine, a second position sensor for detecting a second actual position of the actuator, the computing unit, and in particular a second operating device. The computing unit is to this extent assigned to both the main system and the backup system. The computing unit is configured to detect the actual speeds simultaneously and independently of each other according to the method described above, to detect the actual positions simultaneously and independently, to determine a plausible actual speed and a plausible actual position as a function of the detected actual speeds and/or actual positions, and to operate the actuator to adjust the speed of the internal combustion engine as a function of the plausible actual speed and the plausible actual position. It is even more preferably provided that the two operating devices are assigned to the one actuator, wherein a first operating device is assigned to the main system and a second operating device is assigned to the backup system, wherein preferably only the operating device whose system is supplying a plausible actual position and a plausible actual speed is activated. This results in the advantages described above. In the following, the invention is explained in greater detail on the basis of the drawing, consisting of a single figure.

The FIGURE shows a simplified functional block diagram of an advantageous device for the redundant control of the actuator of an internal combustion engine.

The FIGURE shows a simplified diagram of a device 1 for controlling the speed of an internal combustion engine (not shown here). By “speed” is meant in particular the rotational speed of a crankshaft of the internal combustion engine. Of course, it could also mean the rotational speed of a camshaft or the like. The device 1 comprises a sensor device 2, a plausibility-determining device 3, a computing unit 4, and an operating device 5 for operating an actuator (not shown) of the internal combustion engine, the actuator being movable to adjust in particular the desired flow of fuel to the internal combustion engine, i.e., to the cylinders of the internal combustion engine.

The sensor device 2 comprises a first speed sensor 6 and a second speed sensor 7, which detect, independently of each other, a first actual speed n_{MOT1} and a second speed n_{MOT2} of the internal combustion engine. The speed sensors 6 and 7 are preferably assigned to the same shaft of the engine, in particular to the crankshaft of the engine. Of course, it is also conceivable that one of the speed sensors 6 or 7 could be assigned to one shaft and the other speed sensor 7 or 6 to another shaft of the internal combustion engine. When the sensor signals are subsequently evaluated, it would be necessary for the evaluation of the data merely to take into account the reduction ratios, if any, between the shafts.

The sensor device 2 also comprises a first position sensor 8 and a second position sensor 9, which, independently of each other, detect the position of the actuator. For this purpose, the first position sensor 8 supplies an output value POS1, the second position sensor 9 a second actual position POS2.

The plausibility-determining device 3 receives the actual values detected by the sensors 6-9 and evaluates them as follows. First, the first actual speed is compared with a presettable speed range. The speed range is preferably preset as a function of a predetermined speed of the internal combustion engine, in order that, by means of a comparison of the first actual speed n_{MOT1} with the speed range, it can be determined whether or not the detected speed value would lead to a plausible speed gradient and could thus be judged plausible.

A test is also run to determine whether or not the first actual speed n_{MOT1} corresponds to the second actual speed n_{MOT2} or is at least close to it. If the detected actual speeds agree and they are thus also within the presettable speed range, it is assumed that the system is operating error-free in all respects and the detected values can be used to operate the actuator, i.e., to control the speed.

If, however, the plausibility test indicates that the actual speeds deviate from each other, it is concluded that only one of the actual speeds is plausible. In the present exemplary embodiment, it is concluded that, if the first actual speed n_{MOT1} is within the actual speed range determined by a presettable minimum speed limit and a presettable maximum speed limit, and the second actual speed n_{MOT2} does not correspond to the first actual speed n_{MOT1} and in particular lies outside the allowable speed range, then the first actual speed n_{MOT1} is judged to be the plausible actual speed n_{MOT}.

The procedure is similar for the values of the position sensors 8 and 9. First, the actual positions are compared with each other. If the actual positions POS1 and POS2 are too far apart, only one of the position values is considered plausible. To determine which one is plausible, preferably a comparison with the acquired actual speeds n_{MOT1} and n_{MOT2} is carried out. In particular, the comparison is carried out with the actual speed judged plausible. If the detected actual speed or the actual speed judged plausible does not correspond to the speed to be expected at the currently detected actual position, then the actual position is judged implausible. If, however, the plausible actual speed agrees with one of the actual positions POS1 or POS2, then the actual position which agrees is judged to be the plausible actual position POS.

In the case of the present device 1, the first speed sensor 6, the first position sensor 8, and a first operating device 10 for operating or moving the actuator are assigned to a master or main system, whereas the second speed sensor 7, the second position sensor 9, and a second operating device 11 for operating the actuator are assigned to a backup or failsafe system.

The plausible speed n_{MOT} and the plausible actual position POS are sent to the computing unit 4, which, as a function of these values, carries out the actual speed control function and adapts or changes the position of the actuator to be adjusted as a function of the plausible actual speed and the plausible actual position in order to arrive at the desired actual speed, such as an idling speed.

On the basis of the data to be evaluated, the computing unit 4 decides whether the first operating device 10 or the second operating device 11 or both operating devices 10 and 11 are to be activated. It is preferably provided that, if it is the master system which is making the plausible values available, the first operating device 10 is actuated. If the plausible speed value n_{MOT} and the plausible actual position POS are determined by the backup system, the second operating device 11 is actuated.

The actuator is activated by the operating device 10 or 11 in such a way that the amount of fuel being supplied is adjusted to a certain or a desired value \dot{m} as a result of which the speed of the internal combustion engine is adjusted to a desired level or a specific value.

1-9. (canceled)

10. A method for redundant speed control of an internal combustion engine, comprising a redundantly operable actuator for adjusting the speed, the method comprising the following steps:
detecting a first actual speed and a second actual speed of the internal combustion engine, wherein the actual speeds are detected simultaneously and independently of each other;
detecting a first actual position and a second actual position of the actuator, wherein the actual positions are detected simultaneously and independently of each other;
determining a plausible actual speed and a plausible actual position as a function of the detected actual speeds and/or the detected actual positions; and
operating the actuator for adjusting the speed as a function of the plausible actual speed and the plausible actual position.

11. The method according to claim 10, wherein the plausible actual speed is determined by comparing the detected actual speeds with an allowed, presettable speed range, and judging only an actual speed of the detected actual speeds lying within an allowable speed range to be the plausible actual speed.

12. The method according to claim 10, wherein the plausible actual speed is determined by comparing the detected actual speeds are compared with each other, and if the detected actual speeds deviate from each other by more than a presettable amount, judging the detected actual speed which lies within an allowable, presettable speed range to be the plausible.

13. The method according to claim 10, wherein, if a speed deviation of the actual speeds lies below a presettable limit value and both detected actual speeds lie within an allowable speed range, only one of the two actual speeds, is judged plausible.

14. The method according to claim 13, wherein the first actual speed is judged to be plausible.

15. The method according to claim 10, wherein, if a speed deviation of the actual speeds lies below a presettable limit value, an average value is formed from the detected actual speeds, and the average value is determined to be the plausible actual speed.

16. The method according to claim 10, wherein the detected actual positions are compared with each other and, if the detected actual positions deviate from each other by more than a presettable amount, only one of the detected actual positions, is determined to be plausible.

17. The method according to claim 16, wherein the second detected actual position is determined to be plausible.

18. The method according to claim 10, wherein the first actual position is compared with the first actual speed and the second actual position with the second actual speed, wherein, as a function of the comparison a determination is made whether or not the actual position in question is plausible.

19. The method according to claim 10, wherein two operating devices are assigned to the redundantly operable actuator, wherein the first actual speed and the first actual position are assigned to a first of the operating devices, and the second actual speed and the second actual position are assigned to a second of the operating devices, wherein only the operating device whose actual speed and/or actual position is plausible is activated.

20. A device for redundant speed control of an internal combustion engine, for carrying out the method according to claim 10, the device comprising: a redundantly controllable actuator; a main system for redundant control of the actuator, comprising a first speed sensor for detecting a first actual speed of the internal combustion engine, a first position sensor for detecting a first actual position of the actuator, a computing unit, and a first operating device; and a backup system comprising a second speed sensor for detecting a second actual speed of the internal combustion engine, a second position sensor for detecting a second actual position of the actuator, the computing unit, and a second operating device, wherein the computing unit is configured to detect the actual speeds simultaneously and independently of each other, to detect the actual positions simultaneously and independently, to determine a plausible actual speed and a plausible actual position as a function of the detected actual speeds and/or the detected actual positions, and to operate the actuator to adjust the speed of the internal combustion engine as a function of the plausible actual speed and the plausible actual position.
